(19) United States
(12) Patent Application Publication
(10) Pub. No.: US 2026/0157374 A1
(43) Pub. Date: Jun. 11, 2026

(54) USE OF ALUMINOSILICATE POLYMERS AS AN ACTIVE INGREDIENT AGAINST PHYTOPATHOGENIC MICROORGANISMS

(71) Applicants: COMMISSARIAT A L'ENERGIE ATOMIQUE ET AUX ENERGIES ALTERNATIVES, Paris (FR); Centre National De La Recherche Scientifique, Paris (FR)

(72) Inventors: Pierre PICOT, GIF-SUR-YVETTE (FR); Antoine THILL, GIF-SUR-YVETTE (FR)

(73) Assignees: COMMISSARIAT A L'ENERGIE ATOMIQUE ET AUX ENERGIES ALTERNATIVES, Paris (FR); Centre National De La Recherche Scientifique, Paris (FR)

(21) Appl. No.: 18/875,956

(22) PCT Filed: Jun. 26, 2023
(86) PCT No.: PCT/EP2023/067323

§ 371 Date: Dec. 17, 2024

(30) Foreign Application Priority Data
Jun. 27, 2022 (FR) FR2206380

(51) Int. Cl. A01N 59/06; A01N 25/10; A01N 59/00; A01P 1/00; A01P 3/00

(52) U.S. Cl. CPC A01N 59/06; A01N 25/10; A01N 59/00; A01P 1/00; A01P 3/00

(57) ABSTRACT

The use of aluminosilicate polymers having an imogolite local structure and derivatives thereof as an active ingredient against phytopathogenic microorganisms, in particular Plasmopara viticola, which is the cause of downy mildew in grapevines. Also, a method for combating the occurrence of diseases caused by phytopathogenic microorganisms in plants. The method includes at least on step of applying, to the plants, a compositing having at least one aluminosilicate polymer having an imogolite local structure and derivatives thereof as an active ingredient.

### FIELD

The present invention applies to the general field of phytosanitary products and combating phytopathogenic microorganisms. In particular, the invention relates to the use of aluminosilicate polymers of the imogolite or allophane type as an active ingredient against phytopathogenic microorganisms, in particular phytopathogenic fungi such as pseudofungi of the Peronosporaceae family of the Oomycetes class such as Plasmopara viticola, which is responsible for downy mildew, and phytopathogenic bacteria. The invention also relates to a method for combating the onset of diseases caused by phytopathogenic microorganisms in plants comprising at least one step of applying, to said plants, a composition comprising at least one aluminosilicate polymer of the imogolite or allophane type as active ingredient.

### BACKGROUND

For a farmer, the diseases to which his plants are regularly exposed can have disastrous consequences on the yields, quality and survival of his crops. For example, soft rot, which causes plant necrosis, can lead to major economic losses.

The phytosanitary products or pesticides used in agriculture limit the development of organisms likely to affect crops and harvests. Attackers are phytopathogenic microorganisms and include fungi and bacteria.

For example, downy mildew is a fungal disease that affects the leaves and clusters of grapevines in particular, but is also found on other crops (potatoes, tomatoes, etc.). This is a disease that affects all French vineyards (to varying degrees depending on the wine-growing region), with parasite pressure becoming high almost every other year. Furthermore, if left untreated, it can lead to: deformed shoots, increased grapevine vulnerability, deterioration in wine quality and a drop in yield (up to 85%).

At present, viticulturists have two ways of combating downy mildew on grapevines: conventional control (prophylactic measures and pesticides) and biocontrol products. Prophylactic measures such as trellising, careful trimming and pruning are labor-intensive and of limited effectiveness. Pesticides used to combat downy mildew (folpel, mancozeb, fosetyl, etc.) are synthetic chemical products. These are the only effective means to date of preventing and/or curbing disease, but their use is highly controversial.

Since the end of the 19th century and the development of the Bordeaux mixture, copper has been a major component of crop protection methods against various diseases (downy mildews, certain fungal diseases and most bacterial diseases), particularly on grapevines, fruit and vegetable crops. While copper is still widely used in various forms of so-called “conventional” agriculture, alongside other pesticides, it plays a crucial role in organic farming systems, as it is currently the only active substance approved for use in organic farming with both a strong biocidal effect and a wide range of actions. However, copper-based compounds accumulate in soils and are toxic to humans, microorganisms and the environment. While most uses of copper are justified by its biological efficacy, they pose ecotoxicological problems (proven risks for soil microbial populations, earthworms, certain aquatic organisms and crop auxiliaries). The evidence of copper's environmental impact has led to regulatory restrictions on its use (capping of applicable doses per hectare per year), and even to its banning as a pesticide in certain European countries (Netherlands, Denmark), generating distortions of competition between countries.

Biocontrol is the alternative of choice for limiting the public health and environmental risks of crop treatments. Biocontrol products are “agents and products using natural mechanisms as part of integrated pest management” (according to Article L253-6 of the French Rural and Maritime Fishing Code). They include macro-organisms (invertebrates, insects, mites or nematodes), micro-organisms (fungi, bacteria, viruses), chemical mediators such as sex pheromones, and natural substances (substances of plant, animal or mineral origin). These products, used at the start of the season when pest pressure is low to moderate, are highly effective. However, they are used in combination with more conventional phytosanitary products (copper for downy mildew and sulfur for another fungal disease, powdery mildew), thereby reducing the quantities of these conventional pesticides used. However, when pest pressure is high, at flowering for example, biocontrol products are ineffective.

Lastly, perhydrol or hydrogen peroxide has known bactericidal and fungicidal effects, with high oxidizing power (OP) due to the highly reactive O—O bond. It is a biocide authorized by the European Union and used for plant protection. However, its instability over time means that this compound cannot be used as a preventive product, particularly in viticulture.

There is therefore a need for new, affordable products with efficacy comparable to that of copper-based products, which can be used throughout the season and have a low environmental impact.

### SUMMARY

Thus, the aim of the present invention is to overcome the drawbacks of the aforementioned prior art and to provide a solution for effectively combating phytopathogenic microorganisms and thus preventing or delaying the onset of diseases caused by phytopathogenic microorganisms in plants.

The first object of the present invention is thus to use at least one aluminosilicate polymer with an imogolite local structure as an active ingredient against phytopathogenic microorganisms.

According to the invention, an imogolite local structure (or ILS) is characterized by the association of aluminum and silicon atoms with an Al/Si ratio of 2:1. In the ideal structure, aluminum atoms are coordinated octahedrally, linked together by edges. The silicon atoms are isolated and in tetrahedral coordination. They are connected to the dioctahedral aluminum layer by three Si—O—Al bonds (see 3D representation in attached FIG. 1).

ILS-type aluminosilicate polymers include imogolites, allophanes and proto-imogolites, their respective derivatives and mixtures thereof.

### BRIEF DESCRIPTION OF THE FIGURES

FIG. 1 is a schematic 3D representation of the local ILS structure. In this figure, the aluminum octahedrons are shown in white and shades of gray, the silicon tetrahedron in black and the spheres corresponding to oxygen atoms. Hydrogen atoms are not shown;

FIG. 2 is a schematic 3D representation of the imogolite structure. In this figure, aluminum octahedrons are shown in white and shades of gray, silicon tetrahedrons in black, and spheres represent oxygen atoms. Hydrogen atoms are not shown;

FIG. 3 is a schematic 3D representation of the allophane structure. In this figure, aluminum octahedrons are shown in white and shades of gray, silicon tetrahedrons in black, and spheres represent oxygen atoms. Hydrogen atoms are not shown;

FIG. 4 is a schematic 3D representation of the proto-imogolite structure. In this figure, aluminum octahedrons are shown in white and shades of gray, silicon tetrahedrons in black, and spheres represent oxygen atoms. Hydrogen atoms are not shown;

FIG. 5 is a cryo-transmission electron microscopy (cryo-MET) photograph of the predominantly (>90% by weight) imogolite aluminosilicate polymer prepared in Example 1;

FIG. 6 is a cryo-transmission electron microscopy (cryo-MET) photograph of the predominantly (>90% by weight) allophane aluminosilicate polymer prepared in Example 2;

FIG. 7 is a cryo-transmission electron microscopy (cryo-MET) photograph of a mixture of imogolite, allophane and proto-imogolite aluminosilicate polymers prepared in Example 3;

FIG. 8 shows the percentage inhibition of in vitro growth on grapevine leaf discs of the Plasmopara viticola fungus of a composition comprising a majority (>90% by weight) of an imogolite-type aluminosilicate polymer and hydrogen peroxide (formulation 1) as a function of the dose tested (in g/L);

FIG. 9 shows the percentage inhibition of in vitro growth on grapevine leaf discs of the Plasmopara viticola fungus of a composition comprising a majority (>90% by weight) of an imogolite-type aluminosilicate polymer (formulation 2) as a function of the dose tested (in g/L);

FIG. 10 shows the percentage inhibition of in vitro growth on grapevine leaf discs of the Plasmopara viticola fungus of a composition comprising a majority (>90% by weight) of an allophane-type aluminosilicate polymer and hydrogen peroxide (formulation 3) as a function of the dose tested (in g/L);

FIG. 11 shows the percentage inhibition of in vitro growth on grapevine leaf discs of the Plasmopara viticola fungus of a composition comprising a majority (>90% by weight) of an allophane-type aluminosilicate polymer (formulation 4) as a function of the dose tested (in g/L);

FIG. 12 shows the percentage inhibition of in vitro growth on grapevine leaf discs of the Plasmopara viticola fungus of a composition comprising a mixture of aluminosilicate polymers with a local ILS structure, said mixture consisting of 55% by weight imogolite, 40% by weight allophane and 5% by weight protoimogolite (formulation 5) as a function of the dose tested (in g/L),

FIG. 13 shows the histogram of doses inhibiting 50% growth of Plasmopara viticola fungus (IC₅₀), and the minimum inhibitory concentration (MIC) for each of the formulations 1 to 5 tested.

FIG. 14 shows the histogram of the percentage inhibition of Plasmopara viticola fungal growth on grapevines of a composition comprising predominantly (>90% by weight) an allophane-type aluminosilicate polymer as a function of the dose tested (in g/L), or of a composition comprising a majority (>90% by weight) of an allophane-type aluminosilicate polymer and hydrogen peroxide as a function of the dose tested (in g/L), at different allophane concentrations.

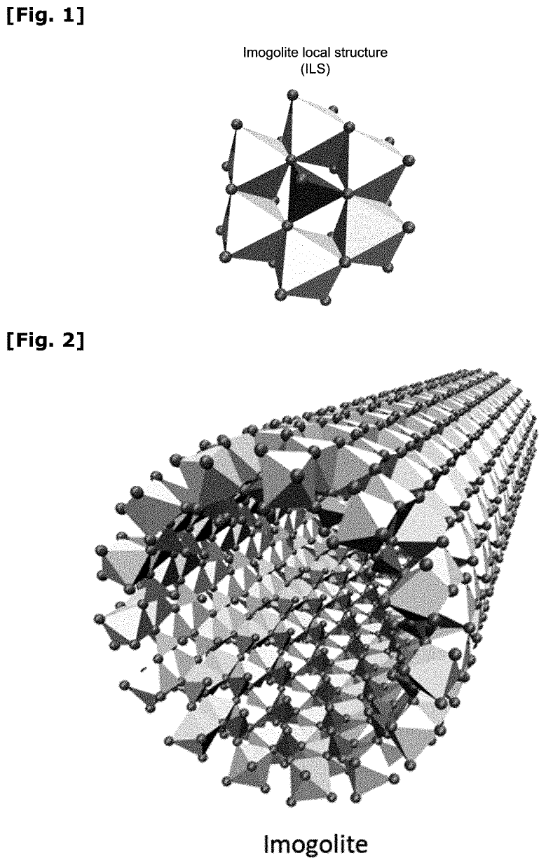

### DETAILED DESCRIPTION

Imogolites are the tubular forms of these ILS-type aluminosilicate polymers. Imogolite is a mineral of the aluminosilicatehydrate family (clay mineral group), with the average chemical formula Al₂SiO₃(OH)₄. It occurs naturally in volcanic ash and some soils. The atomic structure of imogolite was published in 1972 (P. D. G. Cradwick et al, “Imogolite, a hydrated aluminum silicate of tubular structure”, Nature Physical Science, vol. 240, Dec. 25, 1972, p. 187-189). Imogolite has a well-defined nanotubular structure with a monodisperse outer diameter of approx. 2 to 3 nm and a polydisperse length of approx. 10 to 1000 nm (see 3D representation of imogolite in attached FIG. 2).

According to a particular embodiment of the invention, aluminosilicate polymers are selected from imogolite nanotubes and imogolite derivative nanotubes.

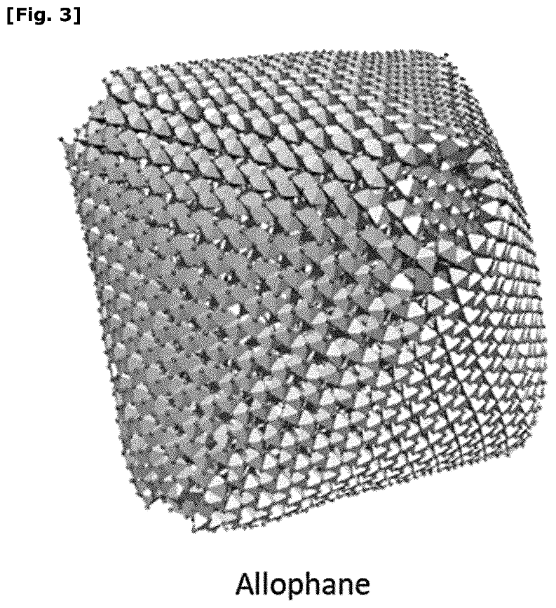

Allophanes are aluminosilicate nanospheres with the average chemical formula Al₂SiO₃(OH)₄. These nanospheres are generally 3 to 5 nm in diameter and also occur naturally in natural deposits. They are related to imogolites in that they share the same local ILS-type structure. A 3D representation of the allophane structure is shown in FIG. 3.

According to a particular embodiment of the invention, aluminosilicate polymers are selected from allophane nanospheres and allophane derivative nanospheres.

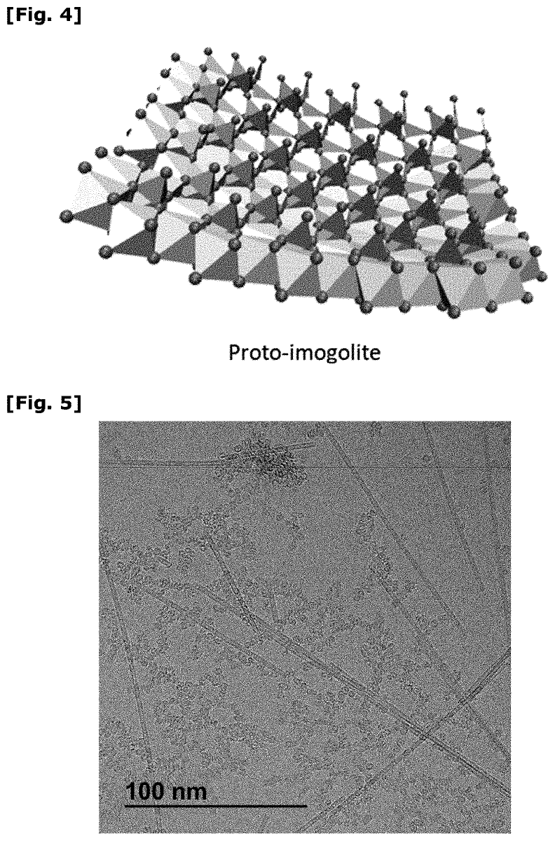

Proto-imogolites are curved, unclosed aluminosilicate nanostructures with a mean chemical formula of Al₂SiO₃(OH)₄ and a size of between 1 and 6 nm, which also occur naturally in natural deposits. They are related to imogolites in that they share the same local ILS-type structure. A 3D representation of the proto-imogolite structure is shown in the attached FIG. 4.

According to a particular embodiment of the invention, the aluminosilicate polymers are selected from non-closed curved proto-imogolite nanostructures and proto-imogolite derivative nanostructures.

Derivatives refer to aluminosilicate polymers with a local ILS-type structure, that is, of the imogolite, allophane or proto-imogolite type, wherein some of the constituent atoms have been replaced by atoms other than aluminum and silicon. For example, these include:
imogolites, allophanes or proto-imogolites, wherein aluminum atoms have been partially replaced by other metal cations such as gallium, indium, iron, cobalt, nickel or copper.
imogolites, allophanes or proto-imogolites wherein silicon atoms have been replaced in whole or in part by other cations such as germanium, arsenic, phosphorus, carbon, aluminum, iron.

These derivatives may also be referred to as doped imogolites, doped allophanes and doped proto-imogolites, respectively.

According to the invention, imogolites, allophanes, proto-imogolites and their doped derivatives can also be functionalized.

Thus, according to the invention, imogolites, allophanes, proto-imogolites and their derivatives can be chosen from aluminosilicate polymers having a local ILS-type structure wherein at least some of the surface hydroxyl groups have been functionalized by a group chosen from alkyl, alkene, alkyne, amino, thiol, halide, phenyl, silane groups and mixtures thereof.

According to a preferred embodiment of the invention, the aluminosilicate polymers are selected from imogolite derivatives in the form of nanotubes with an external diameter ranging from 3 to 3.6 nm, preferably from 3.1 to 3.4 nm, said diameter being measured by Small Angle X-ray Scattering (SAXS), wherein some of the silicon atoms have been replaced by germanium atoms, some of the aluminum atoms have been replaced by iron atoms and some of the hydroxyl groups have been replaced by methyl groups.

Imogolite derivatives, also referred to as “hybrid imogolites”, suitable for use according to the present invention can be prepared according to the method disclosed in international application WO2014/080370.

According to a preferred embodiment of the invention, aluminosilicate polymers are chosen from allophane derivatives in the form of nanospheres with an external diameter ranging from 3 to 6 nm, said diameter being measured by SAXS.

Allophane derivatives, also known as “hybrid allophanes”, for use according to the present invention can be prepared using the method disclosed in patent application FR3 023 181.

According to a preferred embodiment of the invention, proto-imogolite derivatives are selected from nanostructures having a size of between 1 and 6 nm, said size being measured by SAXS.

According to a particular and preferred embodiment of the invention, said aluminosilicate polymers are selected from polymer mixtures consisting of from about 5 to 90% by weight of imogolite and/or an imogolite derivative, from about 5 to 90% by weight of allophane and/or an allophane derivative, and from about 5 to 90% by weight of proto-imogolite and/or a proto-imogolite derivative, the sum of these individual percentages being equal to 100%. Among such mixtures, mixtures consisting of about 40-70% by weight imogolite and/or imogolite derivative, about 30-50% by weight allophane and/or allophane derivative and about 5-20% by weight proto-imogolite and/or protoimogolite derivative are particularly preferred, the sum of these individual percentages being equal to 100%. Among such mixtures, mixtures consisting of about 55% by weight imogolite and/or imogolite derivative, about 40% by weight allophane and/or allophane derivative and about 5% by weight protoimogolite and/or proto-imogolite derivative are particularly preferred.

The use of these aluminosilicate polymers has no long-term impact on the environment, since once incorporated into the soil, these polymers break down into other clays already present (depending on local geology). Their efficacy is comparable to that of conventional copper-based products.

According to a first particular and preferred embodiment of the invention, aluminosilicate polymers are used in combination with hydrogen peroxide.

Indeed, as demonstrated in the examples exemplifying the present invention, the joint use of at least one aluminosilicate polymer and hydrogen peroxide makes it possible to improve the efficacy of aluminosilicate polymers against the growth of plant pathogens and therefore to reduce the doses at which they can be used effectively (reduction in the minimum inhibitory concentration of aluminosilicate polymers).

According to this particular embodiment of the invention, the optional use of hydrogen peroxide also has no environmental impact, since its degradation products are water and oxygen.

Still according to this particular embodiment of the invention, the weight ratio of aluminosilicate polymers to hydrogen peroxide can vary from about 1:0.01 to 1:0.8, and even more preferentially from about 1:0.1 to 1:0.4.

According to a second particular and preferred embodiment of the invention, the aluminosilicate polymers are chosen from undoped allophanes.

This means that these allophanes do not contain metal cations such as gallium, indium, iron, cobalt, nickel or copper. Again according to this embodiment, said undoped allophanes are preferably used without being combined with hydrogen peroxide.

The phytopathogenic microorganisms against which aluminosilicate polymers usable in accordance with the invention are effective can be phytopathogenic fungi or phytopathogenic bacteria.

Among phytopathogenic fungi, particular mention should be made of pseudo-fungi of the Peronosporaceae family of the Oomycetes class, such as Plasmopara viticola responsible for grapevine downy mildew, or those of the Pythiaceae family, such as Phytophthora infestans responsible for potato and tomato downy mildew, Ascomycetes fungi responsible for scab on fruit trees, e.g. Venturia inaequalis responsible for apple scab, or those belonging to the Erysiphales order and the Erysiphaceae family, which are responsible for powdery mildew, e.g. Erysiphe necator responsible for powdery mildew on grapevines, or those belonging to the Helotiaceae family, such as Pseudopezicula tracheiphila responsible for grapevine blight (brenner), or those of the Venturiaceae family, such as Spilocaea oleaginea responsible for cycloconium (peacock's eye disease) of olive trees, or fungi of the Sclerotiniaceae family and the Monilinia genus, including Monilinia fructigena, which mainly attacks pome fruit, and Monilinia laxa, which attacks stone fruit, responsible for moniliosis, or those of the Taphrinales order and the Taphrinaceae family, such as Taphrina deformans responsible for peach blister, or those of the Botryosphaeriaceae family, such as Guignardia bidwellii responsible for black rot, or the necrotrophic fungi necrotrophic botrytis fungi of the Sclerotiniaceae family, such as Botrytis cinerea responsible for grey rot (Botrytis), or those of the Pleosporaceae family, such as Alternaria solani responsible for alternaria blight in tomatoes and potatoes, Phoma fungi of the Sphaerioidaceae family, class Coelomycetes, such as Phomopsis viticola, responsible for excoriosis.

Phytobacteria include Ralstonia solanacearum of the Burkholderiaceae family, responsible for potato brown rot, proteobacteria of the Comamonadaceae family, such as Xylophilus ampelinus responsible for bacterial necrosis of grapevines, or those of the Pseudomonadaceae family, such as Pseudomonas savastanoi responsible for bacterial blight of olive trees, or those of the Xanthomonadaceae family, such as Xanthomonas campestris pv. Vesicatoria responsible for bacterial spots on tomatoes or those of the Pseudomonadaceae family such as Pseudomonas syringae pv. Lachrymans responsible for angular leaf spot on cucumbers.

According to a particularly preferred embodiment, aluminosilicate polymers according to the invention are used as fungicides, especially against pseudo-fungi of the Peronosporaceae family of the Oomycetes class, most preferentially against Plasmopara viticola.

A second object of the invention is a method for combating the onset of diseases caused by phytopathogenic microorganisms in plants, said method comprising at least one step of applying, to said plants, a composition comprising, as active ingredient against said phytopathogenic microorganisms, at least one aluminosilicate polymer having a local ILS-type structure.

Aluminosilicate polymers with a local ILS structure are preferably selected from imogolites, allophanes, proto-imogolites, their respective derivatives and mixtures thereof.

According to this second object, aluminosilicate polymers are as defined according to the first object of the invention.

Similarly, the phytopathogenic microorganisms targeted by the method according to the invention are those listed above according to the first object of the invention.

In this way, the method disclosed herein can be used to combat plant diseases caused by phytopathogenic fungi or bacteria.

According to a particular and preferred embodiment of the invention, the method is a method for combating plant diseases caused by pseudo-fungi of the Peronosporaceae family of the Oomycetes class, most preferentially for combating Plasmopara viticola. According to this particular embodiment, the method is applied to the treatment of grapevines, potato plants or tomato plants, most preferentially grapevines.

According to a preferred embodiment of the invention, the composition is a liquid composition comprising said at least one aluminosilicate polymer and water.

The concentration of aluminosilicate polymer in said composition generally ranges from about 0.1 to 100 g/L, preferentially from about 0.2 to 50 g/L and even more preferentially from about 0.5 to 30 g/L.

The composition used according to the method disclosed herein may also be in the form of a concentrated composition to be diluted, a powder or granules to be dispersed at the time of use at the desired concentration.

According to a first preferred embodiment of the invention, said composition contains hydrogen peroxide. In this case, the amount of hydrogen peroxide generally ranges from 0.05 to 50 g/L, preferentially from about 0.1 to 25 g/L and even more preferentially from about 0.25 to 15 g/L.

Again according to this embodiment, the weight ratio of aluminosilicate polymers to hydrogen peroxide preferably ranges from about 1:0.01 to 1:0.8, and even more preferentially from about 1:0.1 to 1:0.4.

According to a second preferred embodiment of the invention, said composition does not contain hydrogen peroxide. In this case, aluminosilicate polymers are preferably chosen from allophanes, and even more preferentially from undoped allophanes.

The composition used according to the method according to the invention may further contain one or more adjuvants conventionally used in crop protection products, such as spraying agents, defoaming agents, wetting agents, thixotropic agents, compatibilizing agents, pH stabilizing agents, etc.

The application step may consist in spreading or spraying said composition onto the aerial parts of the plant to be treated.

The amount of composition applied to the plants may vary according to the concentration of aluminosilicate polymers in said composition.

In this way, the amount of composition applied to the plants will be adapted so that the dose of aluminosilicate polymers is between about 100 g and 5 kg per hectare, and preferably between about 500 g and 3 kg per hectare.

The method according to the invention can comprise several application steps over time, depending on the species of plant to be treated, weather conditions and the forecast occurrence of phytopathogenic microorganisms. By way of example, when the method is used to combat downy mildew, particularly on grapevines, the number of applications of said composition preferably varies from 5 to 15 applications per year on average, with a first application in spring, for example in April, followed by subsequent applications every 4 days to every 2 to 3 weeks depending on weather conditions.

Other features, variants and advantages of the method according to the invention will become clearer on reading the following examples, given by way of illustration and non-limitation of the invention, as well as the appended figures.

### EXAMPLES

Reagents and materials used in the examples:
Aluminum chloride hexa hydrate (AlCl₃·6(H₂O)), 99% pure, Sigma-Aldrich,
Nona aluminum perchlorate hydrate (Al(ClO₄)₃·9(H₂O)), 99% pure, Sigma-Aldrich,
Sodium hydroxide (NaOH), 98% pure, Sigma-Aldrich,
Tetraethoxysilane (Si(OCH₂CH₃)₄), 99% pure, Sigma-Aldrich,
Deionized water,
Tangential ultrafiltration membrane (300 kDa retention threshold) in polysulfone, sold under the trade name UF20M3 by Polymem,
Dialysis membrane with a retention threshold of 6-8 kDa, sold under the trade name Spectra/Por™ 1 6-8 kD by Spectrum™ Labs,
110-volume hydrogen peroxide (H₂O₂ 30% by weight), Thermo Scientific,
Sporangia of Plasmopara viticola (Strain Pv2543_1, Hungary sampled in 2013).

### Example 1: Synthesis of a Predominantly (>90% by Weight) Imogolite-type Aluminosilicate Polymer (Clay 1)

To a deionized water solution containing 2 mM Al(ClO₄)₃·9(H₂O) was added, with stirring, tetraethoxysilane until a Si/Al molar ratio equal to 0.55 was reached. After 30 minutes of stirring, a 0.1 M NaOH solution was added until a NaOH/Al molar ratio of 2 was reached, still with stirring. The solution was then left to stir for 4 hours and heated at 90° C. for 7 days. Once cooled, the solution was then concentrated by tangential ultrafiltration with a 300 kDa polysulfone membrane until a concentration factor of 100 was reached. The resulting concentrated solution was then dialyzed in a dialysis coil consisting of a Spectra/Por™ membrane with a retention threshold of 6-8 kDa against deionized water, until the conductivity of the dialysis water was below 2 μS/cm. The attached FIG. 5 shows a cryo-transmission electron microscopy (cryoMET) photograph of Clay 1 obtained in this way.

### Example 2: Synthesis of a Predominantly (>90% by Weight) Allophanetype Aluminosilicate Polymer (Clay 2)

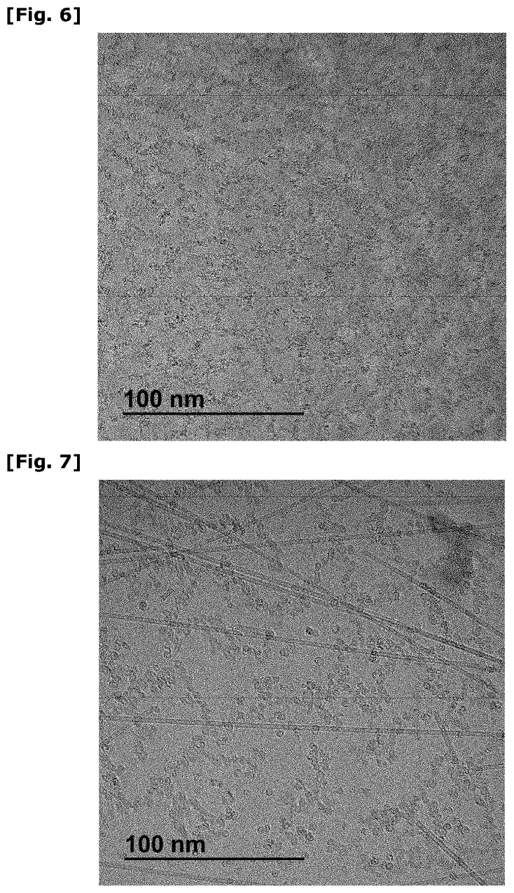

To a deionized water solution containing 200 mM AlCl₃—6(H₂O) was added, with stirring, tetraethoxysilane until a Si/Al molar ratio equal to 0.55 was reached. After 30 minutes of stirring, a 0.1 M NaOH solution was added until a NaOH/AI molar ratio of 2 was reached, still with stirring. The solution was then left to stir for 4 hours and heated at 90° C. for 7 days. Once cooled, the solution was then dialyzed in a dialysis coil consisting of a Spectra/Por™ membrane with a retention threshold of 6-8 kDa against deionized water until the conductivity of the dialysis water was below 2 μS/cm. The attached FIG. 6 shows a cryo-transmission electron microscopy (cryo-MET) photograph of Clay 2 obtained in this way.

### Example 3: Synthesis of a Mixture of Imogolite, Allophane and Protoimogolite Aluminosilicate Polymers (Clay 3)

To a deionized water solution containing 2 mM AlCl₃—6(H₂O) was added, with stirring, tetraethoxysilane until a Si/Al molar ratio equal to 0.55 was reached. After 30 minutes of stirring, a 0.1 M NaOH solution was added until a NaOH/Al molar ratio of 2 was reached, still with stirring. The solution was then left to stir for 4 hours and heated at 90° C. for 7 days. Once cooled, the solution was then concentrated by tangential ultrafiltration with a 300 kDa polysulfone membrane until a concentration factor of 100 was reached. The resulting concentrated solution was then dialyzed in a dialysis coil consisting of a Spectra/Por™ membrane with a retention threshold of 6-8 kDa against deionized water, until the conductivity of the dialysis water was below 2 ρS/cm. A mixture of aluminosilicate polymers consisting of about 55% by weight imogolite, about 40% by weight allophane and about 5% by weight proto-imogolite (Clay 3) was obtained. The attached FIG. 7 shows a cryo-transmission electron microscopy (cryo-MET) photograph of Clay 3 obtained in this way.

### Example 4: Demonstrating the Efficacy of 5 Formulations Based on Aluminosilicate Polymers Against the Agent Responsible for Grapevine Downy Mildew, Plasmopara viticola, In Vitro

The aim of this example is to demonstrate the efficacy of different liquid formulations based on aluminosilicate polymers as prepared above in Examples 1 to 3, respectively Clays 1 to 3, optionally in the presence of hydrogen peroxide, against the agent responsible for downy mildew on grapevines.

### 4.1 Characteristics of Formulations Tested

Various liquid formulations based on deionized water, clays and, optionally, hydrogen peroxide have been prepared. The characteristics of the various liquid formulations tested are detailed in Table 1 below:

TABLE 1

| Formula- | Volume | | Clay | H₂O₂ |
|---|---|---|---|---|
| tions | prepared | Composition | concentration | concentration |
| F1 | 20 mL | Clay 1 + H₂O₂ | 5 g/L | 2.5 g/L |
| | | 30% m. | | |
| F2 | 20 mL | Clay 1 | 5 g/L | — |
| F3 | 20 mL | Clay 2 + H₂O₂ | 5 g/L | 2.5 g/L |
| | | 30% m. | | |
| F4 | 20 mL | Clay 2 | 5 g/L | — |
| F5 | 20 mL | Clay 3 | 5 g/L | — |

### 4.2 Efficacy Test Protocol

Discs with a diameter of 18 mm were cut from grapevine leaves and placed in Petri dishes, top side in contact with Whatman paper.

Each of the above formulations 1 to 5 has been tested at different doses as detailed in Table 2 below:

TABLE 2

| Doses tested | Clay concentrations (g/L) |
|---|---|
| D1 | 0.25 |
| D2 | 0.50 |
| D3 | 0.75 |
| D4 | 1.00 |
| D5 | 1.50 |
| D6 | 3.00 |
| D7 | 5.00 |

The different doses tested were obtained by diluting each of formulations 1 to 5 with deionized water.

For each of formulations 1 to 5, each of the doses tested was applied using a microdiffuser to grapevine leaves at a rate of 1 mL of formulation tested per Petri dish, and at a rate of 6 to 8 leaf discs per concentration tested.

The grapevine leaf discs were then dried before inoculation with the phytopathogenic agent (extemporaneous tests).

Inoculation was carried out using a suspension in sterile water of sporangia of the fungus Plasmopara viticola at a concentration of between 40,000 and 50,000 sporangia/mL at a rate of 3 drops of 15 μL per grapevine leaf disc. The development of the pathogen was evaluated after 7 days incubation at 22° C. as a percentage of growth. These data were then transformed into the average percentage of fungus growth inhibition in the treated modalities compared to the control modality (sprayed with sterile water), according to the following equation 1:

$$\% inhibition = 100 x [ 1 - \frac{\% treated growth}{\% contro1 growth} ] \qquad [ Equation 1 ]$$

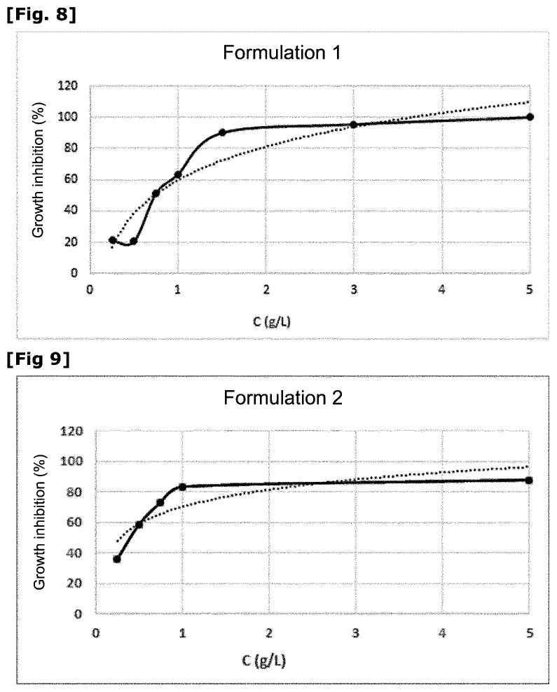

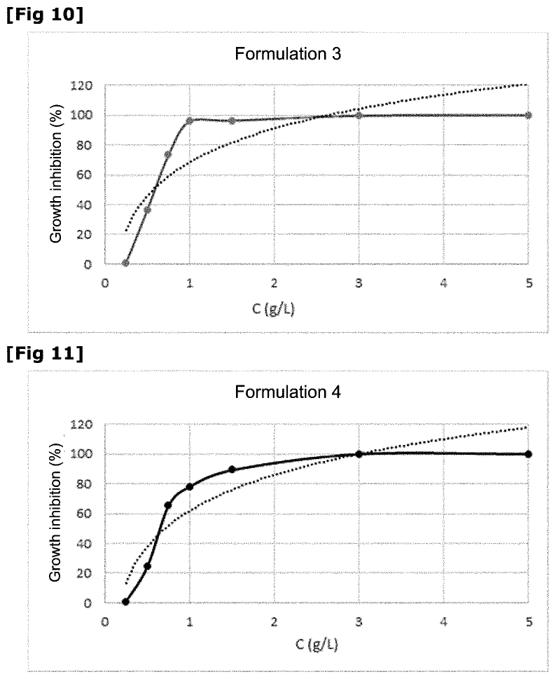

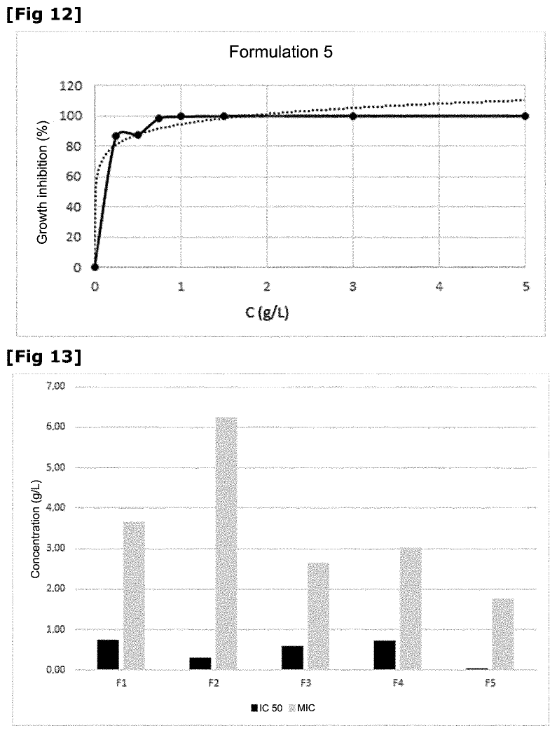

For each of the formulations tested, it is then possible to plot a curve representing the evolution of the percentage of inhibition as a function of clay concentration (in g/L) and thus to determine a value corresponding to the dose inhibiting 50% of fungal growth (IC₅₀), as well as the minimum inhibitory concentration (MIC). The results obtained for each of formulations 1 to 5 tested are shown in attached FIGS. 8 to 12, corresponding respectively to the % inhibition of fungal growth calculated for the different doses of formulations 1 to 5 tested (in g/L).

Attached FIG. 13 shows the IC₅₀ and MIC histograms for each of formulations 1 to 5 tested.

The IC₅₀ and MIC values for each of formulations 1 to 5 tested (F1 to F5) are also shown in Table 3 below:

TABLE 3

| | F1 | F2 | F3 | F4 | F5 |
|---|---|---|---|---|---|
| IC₅₀ (g/L) | 0.73 | 0.29 | 0.57 | 0.71 | 0.01 |
| MIC (g/L) | 3.66 | 6.23 | 2.64 | 3.01 | 1.75 |

All these results show that, although not necessary, the addition of hydrogen peroxide significantly increases the efficacy of formulation 1 by about 50% (MIC=3.66 g/L for formulation 1 comprising Clay 1 and hydrogen peroxide versus 6.23 g/L for formulation 2 comprising only Clay 1). This conclusion also applies to the results obtained with Clay 2 (2.64 g/L for formulation 3 containing Clay 2 and hydrogen peroxide versus 3.01 g/L for formulation 4 containing only Clay 2).

Finally, according to the MIC results, formulation 5 based on Clay 3 only (without hydrogen peroxide) is the most effective against downy mildew growth on grapevines (MIC=1.75 g/L).

### Example 5: Demonstrating the Efficacy of 7 Formulations Based on Aluminosilicate Polymers Against the Agent Responsible for Grapevine Downy Mildew, Plasmopara viticola, In Vivo

The aim of this example is to demonstrate the efficacy of different liquid formulations based on aluminosilicate polymers as prepared above in Example 2 (Clay 2), at different concentrations and in the presence or absence of hydrogen peroxide, against the agent responsible for downy mildew on grapevines.

### 5.1 Doses Tested

Liquid formulations F6 to F12 with the composition shown in Table 4 below were prepared:

TABLE 4

| Formula- | Combination | Clay | H₂O₂ |
|---|---|---|---|
| tions/Doses | with H₂O₂ | concentrations (g/L) | concentration (g/L) |
| F6 | Yes | 1.5 | 0.75 |
| F7 | No | 3.0 | — |
| F8 | Yes | 3.0 | 1.5 |
| F9 | No | 6.0 | — |
| F10 | Yes | 6.0 | 3.0 |
| F11 | No | 15.0 | — |
| F12 | Yes | 15.0 | 7.5 |

### 5.2 Efficacy Test Protocol

The experiment was carried out on fused grafted Cabernet Sauvignon plants from Pépinières Mercier (Vix, France).

For each dose tested, 5 plants were used for the fungicidal efficacy tests, which were then carried out in vitro.

Each of the formulations to be tested was therefore sprayed at the doses indicated in Table 4 above onto all the plants using a microdiffuser at a rate of about 20 mL per plant.

To assess the fungicidal efficacy of the different doses, 5 leaves (3^{rd} or 4^{th} leaf from the apex) were taken at a rate of 1 leaf per plant once the plants had dried out immediately after treatment.

The grapevine leaves were then brought back to the laboratory. 20 mm-diameter leaf discs were cut from the treated grapevine leaves.

3 Petri dishes each containing 6 grapevine leaf discs were prepared for each dose tested according to the protocol indicated above in Example 4. In particular, inoculation was carried out using a suspension of sporangia of the fungus Plasmopara viticola at a concentration of between 40,000 and 50,000 sporangia/mL at a rate of 3 drops of 15 μL per leaf disc.

Assessments of pathogen growth were carried out after 7 days incubation at 22° C. according to the protocol indicated above in Example 4.

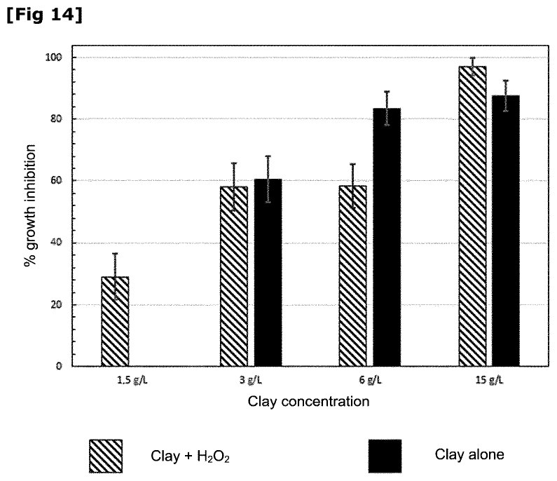

The results obtained are shown in attached FIG. 14, where the inhibition of fungal growth (in %) is given for each of the doses tested (in g/L) in the presence of hydrogen peroxide (crosshatched bars) or in the absence of hydrogen peroxide (black bars).

These results show that spraying a Clay 2-based composition as prepared in Example 2, optionally in combination with hydrogen peroxide, inhibits the growth of downy mildew on grapevines. This example shows that such a composition can therefore be used as a preventive measure in vineyards to prevent the further growth of this phytopathogenic microorganism.

Surprisingly, at some of the clay doses tested (3 g/L and 6 g/L), the use of clay alone is as effective (at 3 g/L), or even more effective (at 6 g/L), than when combined with hydrogen peroxide.

1-17. (canceled)

18. A method of preventing or delaying onset of diseases caused by phytogenic microorganisms in a plant, comprising applying to said plant, at least one aluminosilicate polymer with an imogolite local structure as an active ingredient against phytopathogenic microorganisms.

19. The method according to claim 18, wherein the at least one aluminosilicate polymer is selected from the group consisting of imogolites, allophanes, proto-imogolites, their respective derivatives, and mixtures thereof.

20. The method according to claim 18, wherein the at least one aluminosilicate polymer is selected from polymer mixtures consisting of from 5 to 90% by weight of imogolite and/or an imogolite derivative, from 5 to 90% by weight of allophane and/or an allophane derivative, and from 5 to 90% by weight of proto-imogolite and/or a proto-imogolite derivative, the sum of these individual percentages being equal to 100%.

21. The method according to claim 18, wherein the at least one aluminosilicate polymer is applied in combination with hydrogen peroxide.

22. The method according to claim 18, wherein the at least one aluminosilicate polymer is chosen from undoped allophanes.

23. The method according to claim 22, wherein said undoped allophanes are used without being combined with hydrogen peroxide.

24. The method according to claim 18, wherein the phytopathogenic microorganisms are phytopathogenic fungi or phytopathogenic bacteria.

25. The method according to claim 18, wherein the phytopathogenic microorganisms are pseudo-fungi of the Peronosporaceae family of the Oomycetes class.

26. A method for combating the occurrence of diseases caused by phytopathogenic microorganisms in plants, said method comprising at least one step of applying, to said plants, a composition comprising, as active ingredient against said phytopathogenic microorganisms, at least one aluminosilicate polymer having a local imogolite-type structure.

27. The method according to claim 26, wherein said plants to which said composition is applied are grapevines, potato plants or tomato plants.

28. The method according to claim 26, wherein a concentration of the at least one aluminosilicate polymer within said composition varies from 0.1 to 100 g/L.

29. The method according to claim 26, wherein said composition contains hydrogen peroxide.

30. The method according to claim 26, wherein said composition does not contain hydrogen peroxide and in that the at least one aluminosilicate polymer is chosen from allophanes.

31. The method according to claim 30, wherein the allophanes are undoped allophanes.

32. The method according to claim 26, wherein the step of applying said composition consists of a step of spreading or spraying said composition onto aerial parts of the plant to be treated.

33. The method according to claim 26, wherein a dose of aluminosilicate polymers of between 100 g and 5 kg per hectare is applied.

34. The method according to claim 26, wherein said method is implemented to combat downy mildew, and said composition is applied from 5 to 15 applications per year on average.
